(19) United States
(12) Patent Application Publication
(10) Pub. No.: US 2025/0219340 A1
(43) Pub. Date: Jul. 3, 2025

(54) SLIP RING AND ASSEMBLY METHOD THEREOF

(71) Applicant: CONDUCTIX - WAMPFLER SRL, Agrate Brianza (MB) (IT)

(72) Inventors: Federico Pacciani, Agrate Brianza (MB) (IT); Davide Chiapasco, Agrate Brianza (MB) (IT); Fabio Breviario, Agrate Brianza (MB) (IT)

(21) Appl. No.: 18/867,308

(22) PCT Filed: May 18, 2023
(86) PCT No.: PCT/IB2023/055110

§ 371 Date: Nov. 19, 2024

(30) Foreign Application Priority Data
May 23, 2022 (IT) 102022000010580

(51) Int. Cl. H01R 39/08; H01R 24/64; H01R 43/10; H01R 107/00

(52) U.S. Cl. CPC H01R 39/08; H01R 43/10; H01R 24/64; H01R 2107/00; H01R 2201/04

(57) ABSTRACT

A slip ring comprises a first support body; and a first electric interface associated with said first support body. A plurality of conductive rings fixedly mounted on said first support body and a plurality of first electric tracks in electric connection with said first electric interface and fixedly mounted on said first support body are provided. A plurality of electric contacts, each electric contact being electrically connected to a respective first electric track is provided. A second support body rotatably coupled to said first support body about an axial rotation axis and a second electric interface associated with said second support body and configured to be electrically connected to a second electric component are provided. A plurality of electric brushes fixedly mounted to said second support body and electrically connected to said second electric interface is provided wherein each brush is arranged in sliding contact with a respective conductive ring.

### CROSS-REFERENCE TO RELATED APPLICATION DATA

This application is a U.S. National Stage Application of International Application No. PCT/IB2023/055110, filed May 18, 2023, which claims the benefit of and priority to Italian Patent Application No. 102022000010580, filed May 23, 2022, the disclosure of each is incorporated herein by reference in its entirety.

### FIELD

The present invention relates to a slip ring for transmitting data.

### BACKGROUND

Slip rings are electrical devices used on machines which have components rotating with respect to one another in order to ensure an electrical connection therebetween. Examples of machines which usually employ slip rings include for example: robotic arms, rotating machine tools, carousels, wheels which integrate sensors, articulated camera mounts or other types of sensors.

Slip rings are classified into slip rings for the transmission of electrical power, configured to transmit high-power and low-frequency electrical currents between mutually rotating components, slip rings for the transmission of electric signals, configured to transmit low-power and high-frequency electrical currents (typically data signals) between mutually rotating components, and hybrid slip rings for the transmission of both high-power and low-frequency electrical currents and low-power and high-frequency electrical currents. ‘High-power electrical currents’ is intended as electrical currents with a power greater than 1 W. ‘Low-power electrical currents’ is intended as electrical currents less than 1 W. ‘High-frequency electrical currents’ is intended as electrical currents with a frequency greater than 1 kHz. ‘Low-frequency electrical currents’ is intended as electrical currents with a frequency less than 1 kHz. Some slip rings for the transmission of electrical power can still be used to transmit electrical currents at low power and high frequency, with limitations on the maximum frequency. Similarly, some slip rings for electric signals can still be used to transmit high-power and low-frequency electrical currents, with limitations on the maximum power.

A slip ring usually comprises two mutually rotating parts, each provided with a respective electric interface. The slip ring is installed at the rotation fulcrum of the rotating component of the machine to be connected, so that one of the two parts is integral with the fixed structure of the machine and the other part with the rotating component.

One of the two electrical interfaces is electrically connected to a plurality of conductive rings placed side by side along the rotation axis of the slip ring, and alternating with insulating rings made of electrically insulating material (or empty spaces separating the conductive rings). The other electric interface is connected to a plurality of brushes in sliding contact with respective conductive rings so as to maintain the electrical connection during the mutual rotation of the two parts of the slip ring.

In slip rings for signal transmission, the electric interfaces can consist of respective multi-pin connectors, e.g., female Ethernet connectors, comprising a plurality of pins, or areas provided for soldering respective external conductors, e.g., a plurality of contact pads on a printed circuit board. Each pin (or pad) is electrically connected to a respective conductive ring. Usually, a plurality of electric cables is used to connect the electric interface to the rings, each cable provided with one end soldered to a respective pin (or pad) of the electric interface and with the other end soldered to a respective conductive ring. The plurality of electric cables is housed in the axial cavity defined by the assembly of conductive and insulating rings placed side by side.

Normally, to assemble this type of connector, the electric cables are provided soldered to the respective pins (or pads) of the electric interface, the conductive rings and insulating rings are placed one by one near the connector, and, for each conductive ring, the respective electric cable is passed through the cavity defined by the rings already in place, the end of the electric cable is soldered to the end of the conductive ring, the conductive ring is placed next to the rings already positioned, and the next insulating ring is placed next thereto.

The Applicant has noted that, especially in the case of a slip ring for the transmission of electric (or hybrid) signals, it is of paramount importance that the slip ring preserves the electric signals transmitted therethrough, thus minimising the degradation of the transmitted electric signals. Such degradation is typically due to electromagnetic interference between power cables (known as cross-talk) and parasitic impedance between solders, conductive rings and solder brushes between the electric cables and the conductive rings.

In the Applicant's experience, in order to minimise such degradation of the transmitted electric signals, the electric cables are arranged so that they electromagnetically interfere with each other as little as possible in the path between the multi-pin connector and the conductive rings. Typically, this is achieved by arranging the electric cables in twisted pairs. Furthermore, the solders between the electric cables and the conductive rings must be precisely executed and meet very stringent quality requirements, such as the amount of solder used, the thickness and position of the solders.

The Applicant has noted that limiting the degradation of electric signals in slip rings, as described above, is particularly difficult.

In fact, in the Applicant's experience, applying automated industrial processes for inserting cables into the cavity can be complicated since each electric cable must be passed through the cavity of the already positioned rings twisted over another electric cable and soldered to the respective conductive ring while the rings are positioned side by side. For this reason, these operations are often performed manually by experienced operators, with the consequence that the repeatability of slip ring assembly is not always ensured and with the consequence of increased production costs. Furthermore, this complicates the creation of small rings, where it is even more difficult to arrange cables in a suitable manner and weld them precisely to the conductive rings.

The Applicant has perceived that if the need to solder electric cables to conductive rings was eliminated, the assembly could be simplified, production costs reduced and the degradation of transmitted electric signals limited.

The Applicant has also perceived that if electric cables were replaced with electric tracks mounted on a support body, it would be possible to arrange the electric tracks so as to minimise mutual electromagnetic interference.

The Applicant has found that if the conductive rings were arranged around the support body, it would be possible to arrange each electric track so that it reaches a respective conductive ring.

The Applicant has also found that by arranging each electric track in electric connection with a respective electric contact and arranging such elastically deformable electric contacts so that each conductive ring could be positioned around the support body, elastically deforming a respective electric contact, it would be possible to eliminate any solders between the electric tracks and the conductive rings.

### SUMMARY

Therefore, in a first aspect thereof, the present invention relates to a slip ring comprising:
a first support body;
a first electric interface associated with said first support body and configured to be electrically connected to a first electric component;
a plurality of conductive rings fixedly mounted on said first support body;
a plurality of first electric tracks in electrical connection with said first electric interface and fixedly mounted on said first support body;
a plurality of electric contacts, each electric contact being electrically connected to a respective first electric track and being elastically deformed as it abuts against a respective conductive ring;
a second support body rotatably coupled to said first support body about an axial rotation axis;
a second electric interface associated with said second support body and configured to be electrically connected to a second electric component;
a plurality of electric brushes fixedly mounted to said second support body and electrically connected to said second electric interface, in which each brush is arranged in sliding contact with a respective conductive ring.

In a second aspect thereof, the present invention relates to a method for assembling a slip ring comprising:
providing a first support body, a first electric interface configured to be electrically connected to a first electric component and associated with said first support body, a plurality of first electric tracks electrically connected to said first electric interface and extending on said first support body, a plurality of electric contacts, each electric contact being electrically connected to a respective first electric track and being elastically deformable;
exerting a pressure on said plurality of electric contacts to elastically deform said plurality of electric contacts;
arranging a plurality of conductive rings on said first support body and removing said pressure from said plurality of electric contacts so that each electric contact contacts a respective conductive ring;
coupling in sliding contact a plurality of brushes with respective conductive rings, in which said plurality of brushes is electrically connected with a second electric interface configured to be electrically connected to a second electric component.

The Applicant has verified that the elastic deformation of each electric contact allows each electric contact to exert a contact pressure against a respective conductive ring, ensuring an electrical continuity between electric contact and conductive ring. This makes it possible to avoid soldering the first electric tracks to the respective conductive rings.

The Applicant has also verified that the electric contacts can be elastically deformed before arranging the conductive rings on the first support body, allowing an easy and convenient assembly of the conductive rings on the first support body.

The Applicant has further verified that first electric tracks can be configured to follow predefined and unchangeable paths during the use of the slip ring which minimise the electromagnetic interference therebetween.

The first support body and the second support body of the electric ring are rotatably coupled about a rotation axis. In the present description and the appended claims, expressions such as ‘axial’, ‘axially’, ‘radially’, ‘radially inner’, ‘radially outer’, ‘circumferential’, ‘circumferentially’, are used with reference to such a rotation axis, except where otherwise specified.

The term ‘insulating’ is intended as a component made at least partially of a material which is incapable of conducting electric current due to its dielectric properties.

The term ‘conductive’ is intended as a component made at least partially of a material capable of carrying an electrical current therein and having a resistance less than 1Ω.

The term ‘electric contact’ is intended as an element made of a conductive material.

The term ‘brush’ is intended as an electric component configured to obtain a sliding electric contact with an electric conductor in relative motion with respect thereto.

The term ‘electric connection’ referring to two components is intended as the possibility of transmitting electrical current from one to the other and/or vice versa, either directly or through electric conductors arranged between the two components.

The term ‘elastically deformable’ is intended as the ability of a body to deform when subjected to a force or pressure and to return to its initial condition and shape once the application of such a force or pressure has ceased.

The present invention may have, in one or more of its aspects, at least one of the preferred features described below. Such features can be present individually or in combination with each other, unless expressly stated otherwise.

Preferably, the electric contacts are made as a single piece.

In alternative embodiments, the electric contacts consist of a plurality of pieces, at least one of said pieces being elastically deformable.

Preferably, each electrical contact comprises a first end which is fixed with respect to said first support body and electrically connected to a respective first electric track and a second end in contact against a respective conductive ring.

Preferably, said plurality of electric contacts is arranged radially inside said plurality of conductive rings.

Preferably, said electric contacts are arranged at least 0.5 mm apart from each other, preferably at least 0.8 mm and even more preferably at least 1 mm.

Preferably, each electric contact is arranged at a distance comprised between 0.5 millimetres and 1 centimetre, preferably between 0.8 millimetres and 8 millimetres, more preferably between 0.9 millimetres and 4 millimetres, e.g., approximately 1 millimetre, from an axially adjacent electric contact.

In an embodiment, said first electric tracks follow respective paths of equal length.

Preferably, said first electric tracks are arranged at least 1 mm apart.

Preferably, each first electric track is arranged at a distance comprised between 0.2 millimetres and 1 centimetre, preferably between 0.3 millimetres and 5 millimetres, more preferably between 0.4 millimetres and 2 millimetres, e.g., approximately 1 millimetre, from an adjacent first electric track along a direction perpendicular to an axial direction.

Preferably, said electric contacts are arranged in two rows along parallel axial directions.

Preferably, each electric contact on a first row of said two rows faces, along a direction perpendicular to the axial direction, an empty space dividing two axially adjacent connectors of a second row of said two rows.

The alternating arrangement in two parallel rows increases the mutual distance of the electric contacts, reducing any mutual electromagnetic interference, while maintaining a limited axial encumbrance of the slip ring.

Preferably, the electric contacts in each row are tapered from an axially wide portion facing away with respect to the opposite row to an axially narrow portion facing the opposite row.

Preferably, each electric contact of one row of electric contacts extends, in the direct direction towards the other row of electric contacts, for a length greater than half the distance separating, along the same direction, the first ends of electric contacts of different rows.

Preferably, an ideal line extending in the axial direction and intercepting the electric contacts of both rows is defined.

Preferably, each electric contact comprises a thin plate.

Preferably, such a thin plate has a first end corresponding to the first end of the electric contact and a second end corresponding to the second end of the electric contact.

Preferably, the second end of the thin plate is overlapped on the first end of the thin plate so as to define a curved portion between the first end and the second end.

Preferably, a portion of thin plate extending between the curved portion and the second end is elastically deformed to press against a respective conductive ring.

Preferably, the second end of each thin plate is curved.

Preferably, the second end of each thin plate is tangential to a portion of a conductive ring with which it is in contact.

Preferably, a first printed circuit board is provided axially extended from said first electrical interface within a cavity defined by said conductive rings, said first electric tracks being placed on said first printed circuit board.

Preferably, the first ends of the electric contacts are fixed to the first printed circuit board, preferably soldered.

Preferably, the first printed circuit board is made of rigid material.

Preferably, said first support body comprises a cylindrical support surface counter-shaped with radially inner surfaces of said conductive rings and a recessed seat radially spaced from said radially inner surfaces of said conductive rings.

Preferably, said conductive rings are fitted on said support surface of the first support body.

Preferably, said first printed circuit board is housed in said recessed seat of the first support body.

Preferably, the recessed seat houses the first printed circuit board, the first electric tracks, and the electric contacts.

Preferably, the conductive rings are fitted on said first printed circuit board.

Preferably, exerting a pressure on said plurality of electric contacts to elastically deform said plurality of electric contacts is actuated by compressing said electric contacts with a manoeuvring tool.

Preferably, said manoeuvring tool compresses the second ends of the electric contacts towards the first ends of the electric contacts.

Preferably, compressing the second ends of the electric contacts towards the first ends of the electric contacts with a manoeuvring tool comprises placing said manoeuvring tool in contact with the second ends of the electric contacts and pressing said manoeuvring tool towards said first support body.

Preferably, arranging a plurality of conductive rings on said first support body comprises fitting each conductive ring around said manoeuvring tool and translating said conductive ring along said manoeuvring tool until an axial position of a respective electric contact is reached.

Preferably, compressing the second ends of the electric contacts towards the first ends of the electric contacts with a manoeuvring tool comprises arranging at least part of said manoeuvring tool and said second ends of the electric contacts inside said recessed seat.

Preferably, fitting each conductive ring around said manoeuvring tool and translating said conductive ring along said manoeuvring tool is actuated while arranging at least part of said manoeuvring tool and said second end of the electric contacts inside said recessed seat.

Preferably, removing said pressure from said plurality of electric contacts comprises moving said manoeuvring tool axially away from the recessed seat.

Further features and advantages of the present description will become clearer from the following detailed description of the preferred embodiments thereof, with reference to the appended drawings and provided by way of indicative and non-limiting example, in which:

### BRIEF DESCRIPTION OF THE DRAWINGS

FIG. 1 is a perspective view of a slip ring in accordance with the present invention;

FIG. 2 is a perspective view of the slip ring of FIG. 1 according to a different angle;

FIG. 3 is a section view of the slip ring of FIG. 1;

FIG. 4 is a section view of the slip ring of FIG. 1 orthogonal to the section view of FIG. 3;

FIG. 5 is a perspective view of the slip ring of FIG. 1 with some elements removed to highlight others;

FIG. 6 is a perspective view of the components shown in FIGS. 5, exploded;

FIG. 7 is a perspective view according to a different angle of the components shown in FIG. 5, exploded;

FIG. 8 is a top view of a detail of the slip ring of FIG. 1;

FIG. 9 is a bottom view of the detail of FIG. 7;

FIG. 10 is a top view of a different detail of the slip ring of FIG. 1;

FIG. 11 is a bottom view of the detail of FIG. 10;

FIG. 12 is a section view of some components of the slip ring of FIG. 1 during the assembly of the slip ring.

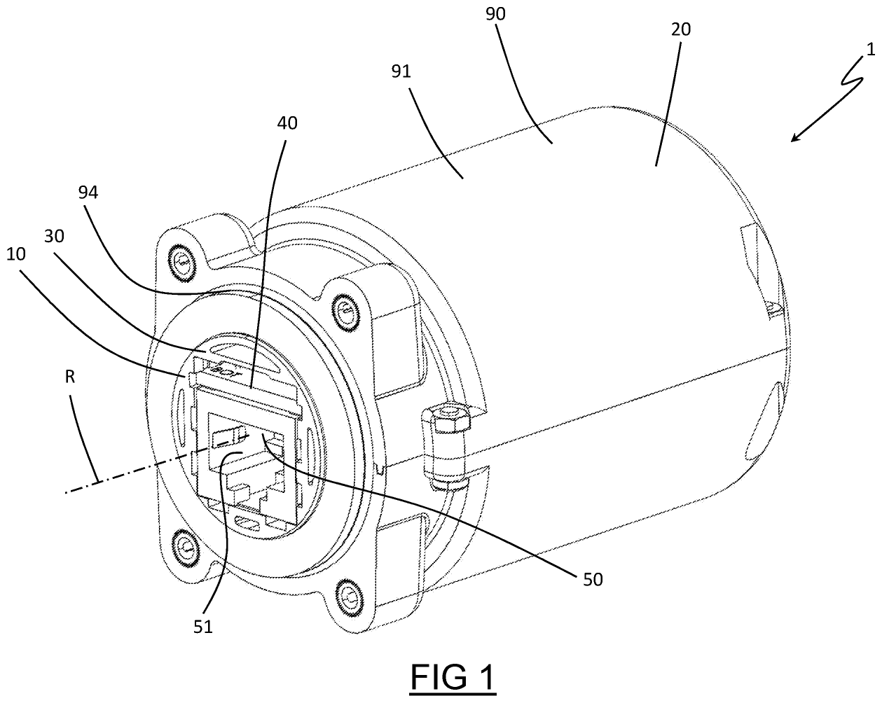

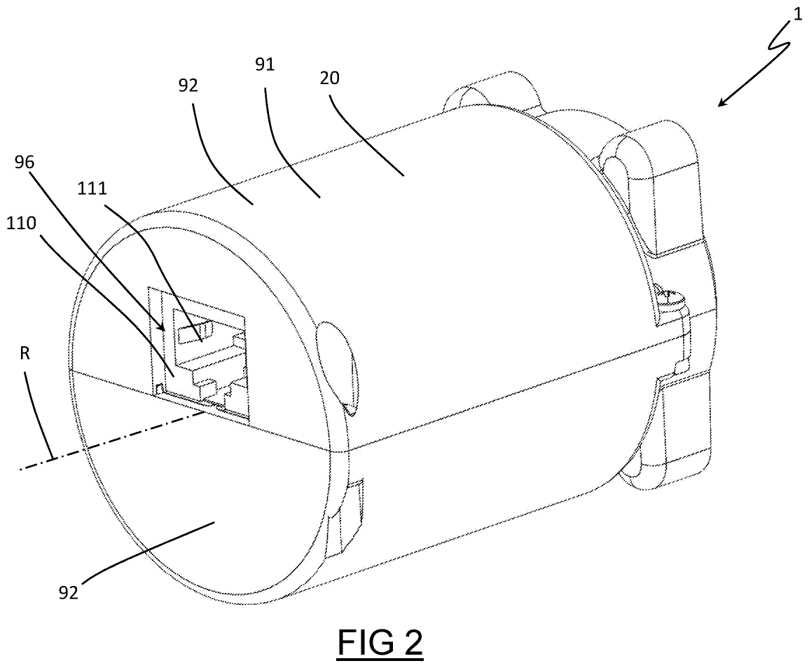

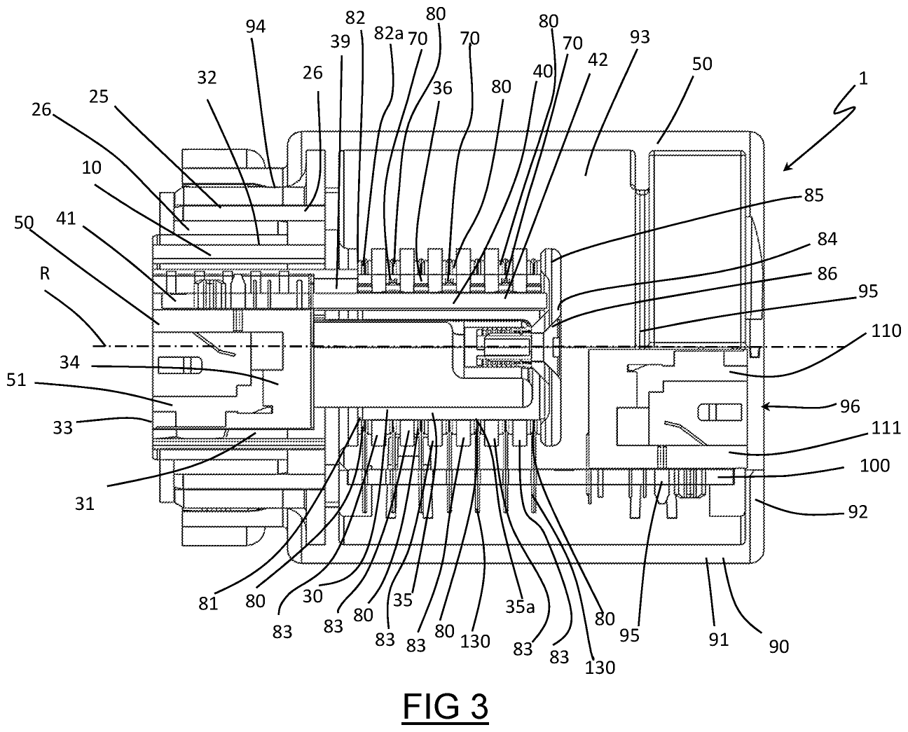

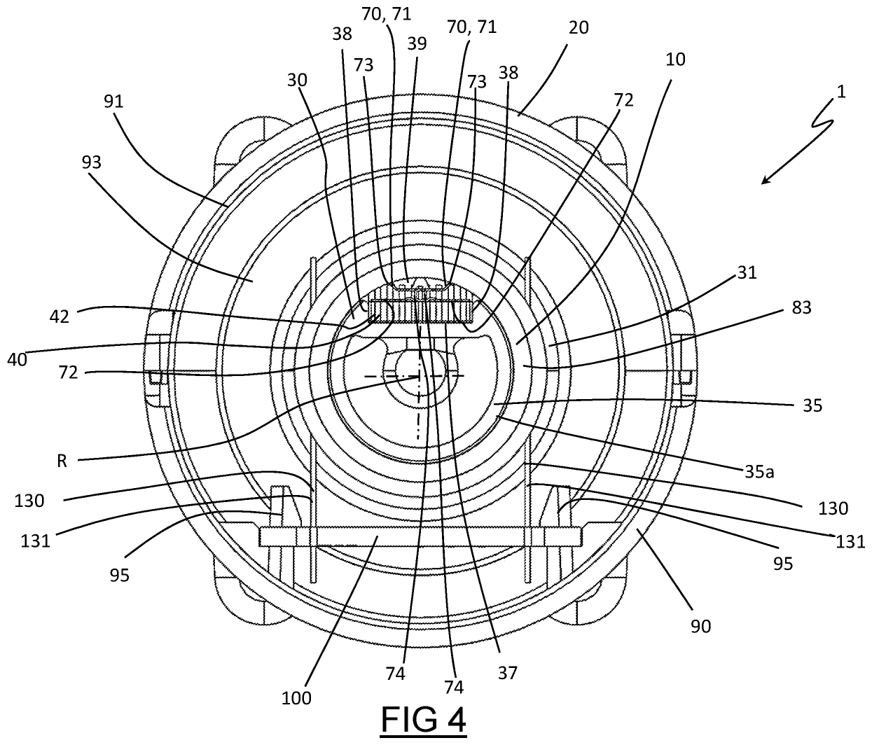

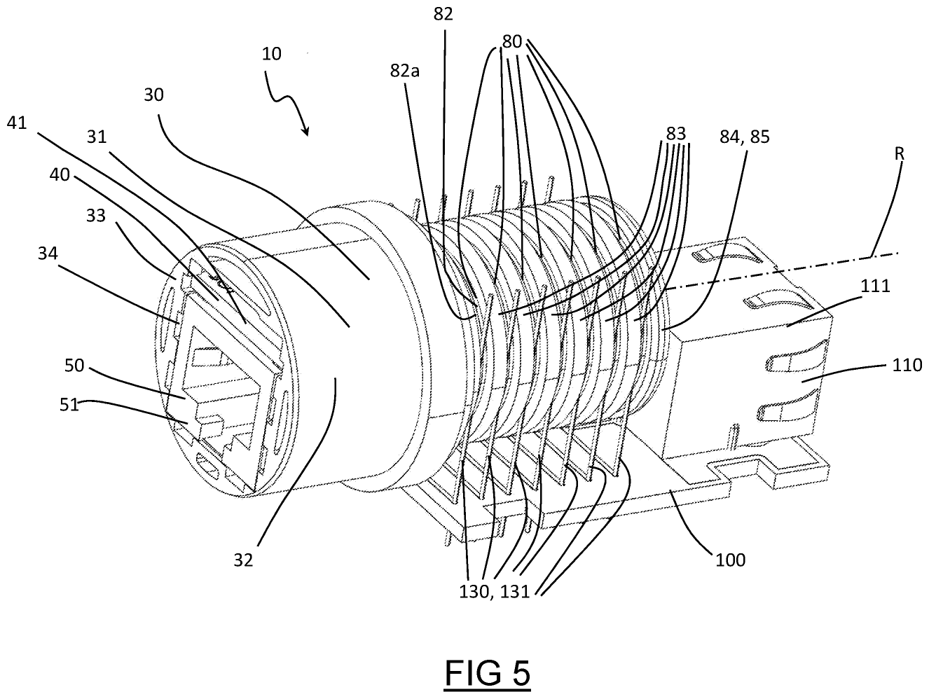

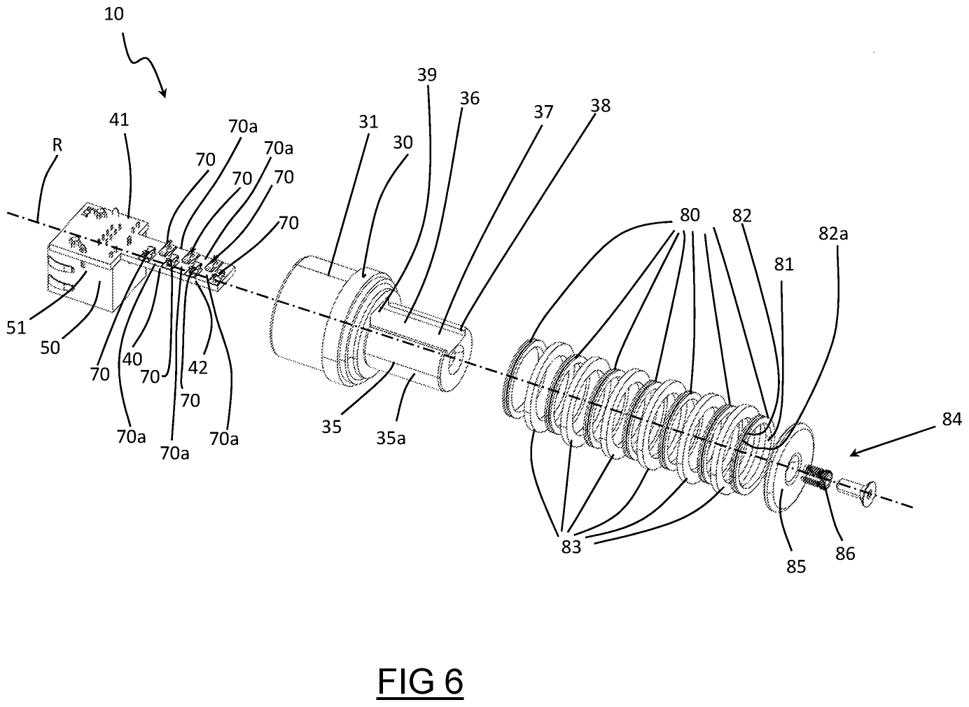

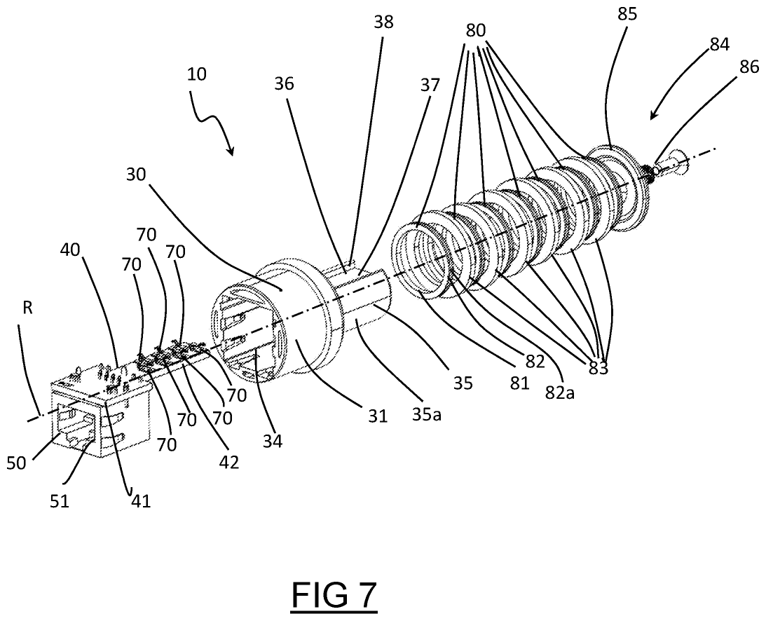

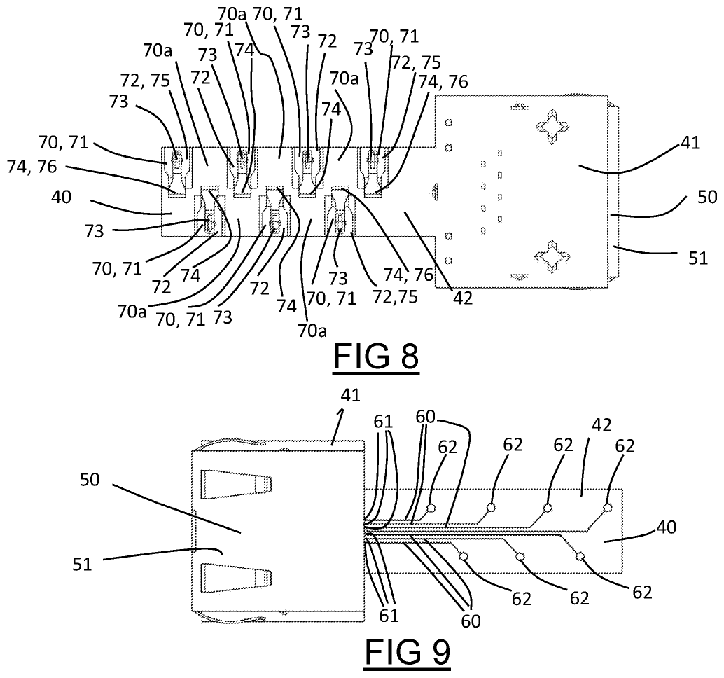

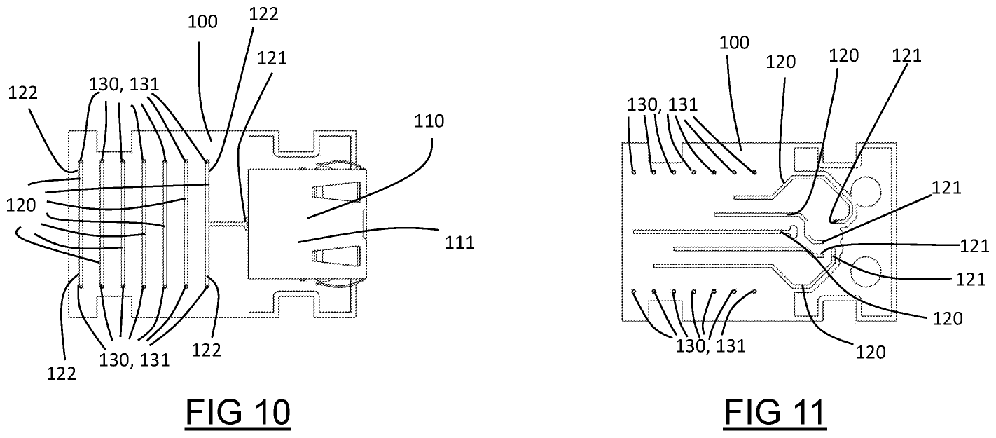

### DETAILED DESCRIPTION

A slip ring, illustrated in the appended drawings, is indicated by the numerical reference 1.

The slip ring 1 comprises a first part 10 and a second part 20 rotatably connected to the first part 10 about a rotation axis R. A rotational coupling member 25 is interposed between the first part 10 and the second part 20, configured to allow the mutual rotation thereof about the rotation axis R. In the embodiment illustrated, the rotational coupling member 25 comprises two concentric bushings 26, integral with the first part 10 and the second part 20, respectively.

The first part 10 comprises a first support body 30, preferably made of an electrically insulating material, e.g., a plastic material. The first support body 30 is extended around the rotation axis R. The first support body 30 comprises a base portion 31 on which the rotational coupling member 25 is mounted. The base portion 31 has a side surface 32 cylindrically extended about the rotation axis R and a base surface 33 orthogonal to the rotation axis R. One of the bushings 26 of the rotational coupling member 25 is fitted on the side surface 32. The base portion 31 further comprises a housing seat 34 open at the base surface 33. The housing seat 34 is preferably arranged along the rotation axis R.

The first support body 30 comprises a first support portion 35 protruding from the base portion 31 on opposite sides of the base surface 33 along the rotation axis R. The first support portion 35 comprises a cylindrical support surface 35a centred on the rotation axis R. The support surface 35a is concentric and has a smaller radius with respect to the outer surface 32.

The first support portion 35 comprises a recessed seat 36 extended parallel to the rotation axis R. The recessed seat 36 has a bottom wall 37 which is radially inner with respect to the support surface 35a and two side walls 38 extending from the bottom wall 37 to the support surface 35a. The bottom wall 37 is flat and extended parallel to the rotation axis R. The side walls 38 are parallel to each other and orthogonal to the bottom wall 37.

The first support body 30 further comprises an opening 39 extending from the housing seat 34 to the recessed seat 36. The opening 39 is obtained in the base portion 31 to put the housing seat 34 in connection with the recessed seat 36. The housing seat 34, the opening and the recessed seat 36 are aligned parallel to the rotation axis R.

The first part 10 comprises a first printed circuit board 40 fixedly retained on the first support body 30 and arranged parallel to the rotation axis R. The first printed circuit board 40 is inserted in the recessed seat 36 against the bottom wall 37, extends through the opening 39 and engages the housing seat 34. The first printed circuit board 40 comprises a first portion 41 arranged in the housing seat 34 and a second portion 42 arranged in the opening 39 and in the recessed seat 36. The second portion 42 has an elongated shape parallel to the rotation axis R. The first portion 41 has a width greater than the second portion 42, measured orthogonally to the rotation axis R. Preferably, the first portion 41 is counter-shaped to the housing seat 34 and the second portion 42 is counter-shaped to the recessed seat 36 so as to stop the first printed circuit board 40 in the direction of the rotation axis R.

A first electric interface 50 is arranged in the housing seat 34, preferably flush with the base surface 33, integral with the first part 10. The first electric interface 50 is accessible from outside the slip ring 1 to connect a first electric component (not shown) to the first part 10 of the slip ring 1. The first electric component can for example be a twisted-pair electric cable, preferably provided with a multi-pin connector.

Preferably, the first electric interface 50 comprises a first multi-pin connector 51 configured to receive the respective multi-pin connector of the first electric component. In the embodiment illustrated, the first multi-pin connector 51 is a female Ethernet connector (socket), specifically the 8p8c type. The first multi-pin connector 51 is soldered on the first printed circuit board 40, in particular to the first portion 41.

In alternative embodiments not illustrated, the first electric interface 50 can comprise, for example, an area of the first printed circuit board 40 arranged for the electric connection with the first electric component by, for example, soldering.

A plurality of first electric tracks 60 is placed on the first printed circuit board 40. Each first electric track 60 is extended from a first end 61 arranged on the first portion 41 in electric connection with the first electric interface 50 to a second end 62 located on the second portion 42 in the recessed seat 36. Each first electric track 60 is arranged in electric connection with a respective pin of the first multi-pin connector 51. The first electric tracks 60 extend from the housing seat 34 to the recessed seat 36 through the opening 39.

In alternative embodiments not illustrated, the first printed circuit board 50 can be integrated in any type of substrate integral with the first support body 30 or can be integral with the first support body 30.

The first part 10 further comprises a plurality of electric contacts 70 made of an electrically conductive and elastically deformable material. Each electric contact 70 is electrically connected to the second end 62 of a respective first electric track 60. In the illustrated embodiment, the electric contacts 70 are soldered on the first printed circuit board 40, in particular on the second portion 42.

Each electric contact 70 comprises a thin plate 71 extended from a first end 72 to a second end 73. The first end 72 is arranged in the recessed seat 36, where it is fixedly connected to the printed circuit board 50 at the second end 62 of the respective first electric track 60, preferably by soldering.

The second end 73 is arranged radially outside the first end 72. The electric contacts 70 are configured so that, in an undeformed condition, the second ends 73 protrude from the recessed seat 36. In other words, in the undeformed condition the second ends 73 protrude outwards from the circumference defined by the support surface 35a. The second end 73 has a concave profile, with the concavity facing the rotation axis R.

The thin plate 71 is folded in a U-shape between the first end 72 and the second end 73 so as to form a curved portion 74 therebetween. The curved portion 74 defines an angle greater than 120°, preferably greater than 150°, between the first end 72 and the second end 73. In the illustrated embodiment, the curved portion 74 defines an angle of 180°.

The thin plate 71 is elastically deformable to allow the first end 72 and the second end 73 to approach each other and so as to exert a force on the second end 73 directed radially away with respect to the rotation axis R. In particular, the thin plate 71 is configured to flex elastically to allow the first end 72 and the second end 73 to approach each other.

The electric contacts 70 are arranged in two rows parallel to the rotation axis R. Preferably, the electric contacts 70 are arranged in an axially alternating distribution between the two rows. In other words, each electric contact 70 of a given row faces an empty space 70a between two successive electric contacts 70 of the opposite row. The electric contacts 70 are mounted at a distance of at least 1 mm from each other.

Each electric contact 70 is mounted with the curved portion 74 facing the opposite row. Preferably, the electric contacts 70 have a tapered shape from an axially wide portion 75 facing away with respect to the opposite row to an axially narrow portion 76 facing the opposite row. In particular, the axially wide portion 75 corresponds to the first end 73 and the axially narrow portion 76 corresponds to the curved portion 74.

The two rows of electric contacts 70 partially interpenetrate so that their respective axially narrow portions 76 are substantially axially aligned with each other.

A plurality of conductive rings 80 is fixedly mounted on the first support body 30. Each conductive ring 80 is made of an electrically conductive material such as copper, brass, aluminium or their alloys, possibly coated with valuable electrically conductive materials such as gold or silver.

The conductive rings 80 are arranged coaxially side by side, parallel to the rotation axis R. The conductive rings 80 have a radially inner surface 81 cylindrically counter-shaped to the support surface 35a, preferably cylindrical. The conductive rings 80 also have a radially outer surface 82 configured to run along one or more brushes. The radially outer surface 82 comprises a circumferential groove 82a within which the respective brush slides. The conductive rings 80 mounted on the support body 30 are fitted on the first support portion 35.

A plurality of insulating rings 83 made of an insulating material, e.g., plastic, is mounted on the first support body 30 coaxial to the plurality of conductive rings 80. The insulating rings 83 are alternated with the conductive rings 80 so that each insulating ring 83 is interposed between two conductive rings 80 to separate and electrically insulate them. The insulating rings 83 are radially and axially thicker than the conductive rings 80.

In alternative embodiments not shown, the insulating rings 83 can be omitted and the conductive rings 80 can be spaced from each other so that the atmospheric air acts as an electrical insulator therebetween.

The conductive rings 80 and the insulating rings 83 side by side define an inner cavity within which the first printed circuit board 40, the plurality of first electric tracks 60 and the plurality of electric contacts 70 arranged in the recessed seat 36 are inserted.

The conductive rings 80 and insulating rings 83 are fixed to the first support body 30 by fixing members 84 configured to compress the conductive rings 80 and insulating rings 83 along the rotation axis R. In the illustrated embodiment, the fixing members 84 comprise a discoidal body 85 having a diameter greater than the support surface 35a and a coupling member 86 configured to clamp the discoidal body 85 to the first support body 30, for example a screw or a bolt.

The radially inner surface 81 of each conductive ring 80 is arranged on the recessed seat 36 in contact with the second end 73 of a respective electric contact 70. Through the electric contact 70, the conductive ring 80 is electrically connected with the first electric interface 50. Both the conductive rings 80 and the electric contacts 70 are mounted integral to the first support body 30 so that there is no sliding or other mutual movement during the use of the slip ring 1.

The second end 73 of each electric contact 70 is arranged against the radially inner surface 81 of the respective conductive ring 80 and is pressed by the conductive ring 80 towards the first end 72. The electric contact 70 is compressed by means of elastic deformation of the curved portion 74. The elastic force 70 exerted by the electric contact 70 maintains the pressure between its second end 73 and the conductive ring 80 and ensures a stable electric connection between the electric contact 70 and the conductive ring 80.

The curvature of the second end 73 of each electric contact 70 makes the second end 73 tangential to the radially inner surface 81 at the contact area so as to reduce the electric contact resistance.

The second part 20 of the slip ring 1 comprises a second support body 90 rotatably coupled to the first support body 30 by means of the rotational coupling member 25.

The second support body 90 has a cup-like shape extended circumferentially about the rotation axis R. The second support body 90 comprises a cylindrical side wall 91 and a flat bottom wall 92.

The second support body 90 defines an inner volume 93 and a cylindrical mouth 94 for access to the inner volume 93, opposite the bottom wall 92. The other of the two bushings 26 of the rotational coupling member 25 is fixed at the mouth 94.

The first part 10 of the slip ring 1 is at least partially housed in the inner volume 93. In particular, the first support portion 35, the electric contacts 70 and the conductive rings 80 and the insulating rings 83 are housed in the inner volume 93. The first printed circuit board 40 and the first electric tracks 60 are at least partially housed in the inner volume 91.

The second support body 90 comprises second support portions 95 protruding from the side wall 91 in the inner volume 93. At the bottom wall 92, the second support body 90 includes a secondary opening 96 for access to the inner volume 93.

The second portion 20 comprises a second printed circuit board 100 fixedly retained to the second support body 90 and arranged in the inner volume 93, parallel to the rotation axis R. The second printed circuit board 100 is retained in position by the second support portions 95. In the embodiment illustrated, the second printed circuit board 100 has a rectangular shape elongated in the direction of the rotation axis R.

A second electric interface 110 is arranged in the inner volume 93 facing the secondary opening 96 so as to be accessible from outside the slip ring 1.

The second electric interface 110 is configured to electrically connect a second electric component (not illustrated) to the second part 20 of the slip ring 1. The second electric component can, for example, be a twisted-pair electric cable, preferably provided with a multi-pin connector, e.g., a male Ethernet connector, specifically the 8p8c type.

Preferably, the second electric interface 110 comprises a second multi-pin connector 111 configured to receive the respective multi-pin connector of the second electric component. In the embodiment illustrated, the second multi-pin connector 111 is a female Ethernet connector (socket), specifically the 8p8c type. The second multi-pin connector 111 is soldered on the second printed circuit board 100.

In alternative embodiments not illustrated, the second electric interface 110 can comprise, for example, an area of the second printed circuit board 100 arranged for the electric connection with the second electric component by, for example, soldering.

A plurality of second electric tracks 120 is placed on the second printed circuit board 100. Each second electric track 120 is arranged in electric connection with a respective pin of the second multi-pin connector 111. Each second electric track 120 is extended from a first end 121 in electric connection with the second electric interface 110 to two second ends 122 arranged near a respective conductive ring 80. The second end 122 is arranged in the same plane orthogonal to the rotation axis R as the respective conductive ring 80.

The second part 20 further comprises a plurality of brushes 130 made of an electrically conductive material, such as copper, brass, aluminium or their alloys, possibly coated in a valuable electrically conductive material such as gold or silver. Each brush 130 is electrically connected to the second end 122 of a respective second electric track 120. In the illustrated embodiment, the brushes 130 are soldered onto the second printed circuit board 100.

Each brush 130 comprises a rod 131 protruding from the second printed circuit board 100 towards a respective conductive ring 80 and arranged in contact with the respective conductive ring 80 tangential thereto so that the mutual rotation of the first part 10 and the second part 20 results in a sliding of the brush 130 on the respective conductive ring 80. Each brush 130 is oriented arranged in a plane orthogonal to the rotation axis R. For each conductive ring 80, there are two brushes 130 parallel to each other and arranged on opposite sides of the conductive ring 80.

The brushes 130 are arranged in electrical connection with the second electric interface 110 through the second electric tracks 120.

Thereby, the first electric interface 50 and the second electric interface 110 are electrically connected to each other in any mutual rotation between the first part 10 and the second part 20 through the first electric tracks 60, the electric contacts 70, the conductive rings 80, the brushes 130 and the second electric tracks 120.

To assemble a slip ring 1 of the type described above, the first printed circuit board 40 on which the first electric tracks 60 are placed is arranged. The first electric interface 50 is arranged at the first ends 61 of the first electric track 60, preferably by soldering each pin of the multi-pin connector 51 to the first end 61 of a respective first electric track 60. Furthermore, the electric contacts 70 are arranged at the second ends 62 of the first electric tracks 60, preferably by soldering the first end 72 of each electric contact 70 to the second end 62 of a respective first electric track 60.

Next, the first printed circuit board 40, the first electric tracks 60, the first electric interface 50 and the electric contacts 70 are associated with the first support body 30. To associate them, the first printed circuit board 40 is inserted in the housing seat 34 so that it engages the opening 39 and the recessed seat 36. In particular, the second portion 42 of the first printed circuit board 40 is advanced through the housing seat 34 and the opening 39 up to the recessed seat 36 and arranged against the bottom wall 37, keeping the electric contacts 70 soldered on the second portion 42 facing away from the bottom wall 37. The first portion 41 is advanced until the first electric interface 50 and the first portion itself 41 are completely housed in the housing seat 34.

The first printed circuit board 40 is fixed to the first support body 30, e.g., by means of adhesives or shape coupling.

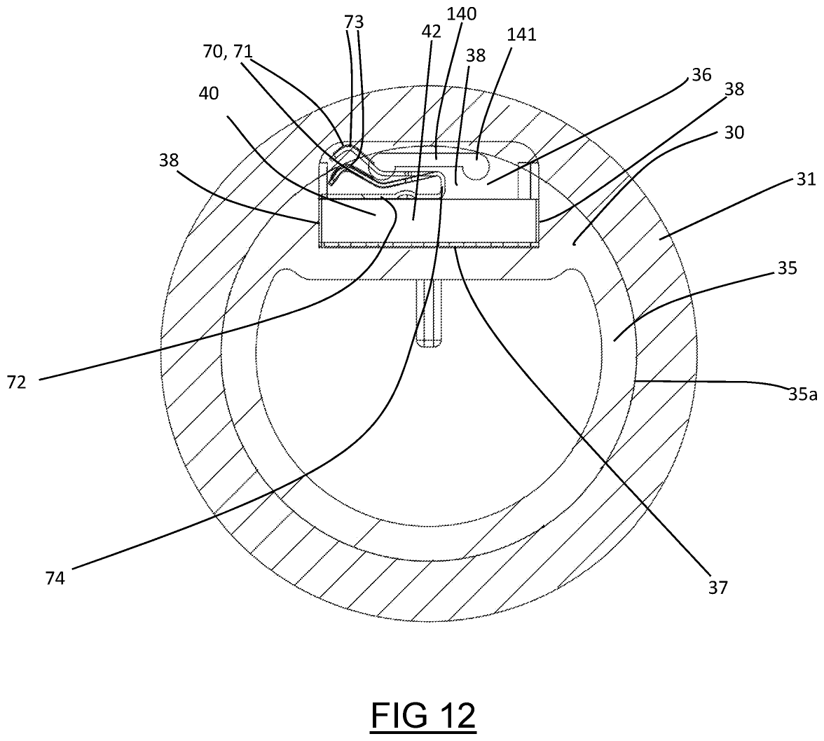

Next, the electric contacts 70 are elastically deformed so as to compress the second ends to the first support body 30, in particular to the bottom wall 37. The electric contacts 70 are deformed so that the second ends 73 towards the recessed seat 36 inside the circumference defined by the support surface 35a. The electric contacts 70 are deformed by compressing the second ends 73 towards the first ends 72 so as to elastically flex the curved portions 74. FIG. 12 shows an electric contact 70 before and after the elastic deformation.

To deform the electric contacts 70, a manoeuvring tool 140, illustrated in cross-section in FIG. 12, is positioned in contact with the second ends 73 and the manoeuvring tool 140 is pressed towards the first support body 30. Preferably, the manoeuvring tool 140 is rod-shaped. The manoeuvring tool 140 is pressed towards the first support body 30, so that one end 141 of the manoeuvring tool 140 radially enters the recessed seat 36 and the manoeuvring tool 140 itself does not engage the circumference defined by the support surface 35a.

While the electric contacts 70 are in an elastically deformed condition, the conductive rings 80 are arranged on the first support body 30. Each conductive ring 80 is fitted on the first support portion 35, in contact with the support surface 35a, and translated sliding along the support surface 35a to a predetermined position in which it is overlapped on the respective electric contact 70. To fit the conductive ring 80 on the support surface 35a, the conductive ring 80 is fitted on the manoeuvring tool 140 (kept under pressure against the electric contacts 70) and the conductive ring 80 is translated along the manoeuvring tool 140 up to its predetermined position on the first support portion 35.

Between each conductive ring 80 and the next conductive ring 80, an insulating ring 83 is arranged on the first support body 30. Each insulating ring 83 is fitted on the first support portion 35, in contact with the support surface 35a, and translated sliding along the support surface 35a until it abuts against the previously fitted conductive ring 80, so that the next fitted conductive ring 80 is arranged abutted on the opposite side against the insulating ring 83. To fit the insulating ring 83 on the support surface 35a, the insulating ring 83 is fitted on the manoeuvring tool 140 (kept under pressure against the electric contacts 70) and the insulating ring 83 is translated along the manoeuvring tool 140 up to its predetermined position on the first support portion 35.

After arranging the conductive rings 80 and insulating rings 83 on the first support body 30, the electric contacts 70 are released so as to cause the elastic return of the second ends 73 against the radially inner surfaces 81 of the conductive rings 80, so that the electric contacts 70 retain sufficient elastic preload to press against the radially inner surfaces 81 with sufficient force to cause a stable, stress-resistant electric connection of the slip ring 1. The electric contacts 70 are released by pulling the manoeuvring tool 140 along the recessed seat 36.

Next, the conductive rings 80 and insulating rings 83 are locked in place by compressing them towards the base portion 31 by means of the fixing members 84. The conductive rings 80 and insulating rings 83 are locked in place by clamping the discoidal body 85 towards the base portion 31.

Next, the second printed circuit board 100 on which the second electric tracks 120 are placed is arranged. The second electric interface 110 is arranged on the second printed circuit board 100, preferably by soldering each pin of the multi-pin connector 111 to the respective second electric track 120. Furthermore, the brushes 130 are arranged by soldering each brush 130 to a respective second electric track 120 on the opposite side of the second printed circuit board 100 from the second electric interface 110.

Next, the brushes 130 are coupled in sliding contact to the conductive rings 80. To couple the brushes 130 to the conductive rings 80, the second printed circuit board 100 is brought closer to the first support body 30 in a radial direction with respect to the conductive rings 80 until the brushes 130 engage the conductive rings 80 with a predetermined contact force.

Then the rotational coupling member 25 is arranged on the first support body 30 and the second support body 90 is assembled. The second support body 90 is assembled so that the mouth 94 engages the rotational coupling member 25, in order to rotatably couple the second support body 90 to the first support body 30 about the rotation axis R. The second support body 90 is also assembled so that the second support portions 95 engage the second printed circuit board 100 and the second electric interface 110 to fixedly retain them to the second support body 90 itself. Assembling the second support body 90, the secondary opening 96 is arranged in front of the second electric interface 110 to allow access to the second electric interface 110 from the outside.

In the illustrated embodiment, the second support body 90 comprises two separate halves 97 and is assembled by arranging each half 97 against the first already assembled part 10 from opposite directions and fixing the two halves to each other.

1. A slip ring comprising:
a first support body;
a first electric interface associated with said first support body and configured to be electrically connected to a first electric component;
a plurality of conductive rings fixedly mounted on said first support body;
a plurality of first electric tracks in electric connection with said first electric interface and fixedly mounted on said first support body;
a plurality of electric contacts, each electric contact being electrically connected to a respective first electric track of the plurality of first electric tracks and being elastically deformed as it abuts against a conductive ring of the plurality of conductive rings;
a second support body rotatably coupled to said first support body about an axial rotation axis;
a second electrical interface associated with said second support body and configured to be electrically connected to a second electrical component;
a plurality of electric brushes fixedly mounted to said second support body and electrically connected to said second electrical interface, wherein each brush is arranged in sliding contact with a respective conductive ring of the plurality of conductive rings.

2. The slip ring according to claim 1, wherein each electric contact of the plurality of electric contacts comprises a first end which is fixed with respect to said first support body and electrically connected to a respective first electric track of the plurality of first electric tracks and a second end in contact against a respective conductive ring of the plurality of conductive rings.

3. The slip ring according to claim 1, wherein said plurality of electric contacts is arranged radially inside said plurality of conductive rings.

4. The slip ring according to claim 1, wherein said plurality of electric contacts are arranged at least 0.5 mm, preferably at least 0.8 mm, even more preferably at least 1 mm apart from each other.

5. The slip ring according to claim 1, in which said plurality of electric contacts are arranged alternately in two parallel axial rows.

6. The slip ring according to claim 1 wherein each of the plurality of electrical contacts comprises a thin plate having a first end corresponding to the first end of the electrical contact and a second end corresponding to the second end of the electrical contact, the second end of the thin plate being overlapped to the first end of the thin plate so as to define a curved portion between the first end and the second end.

7. The slip ring according to claim 6, wherein the second end of each thin plate is curved and tangential to a portion of a conductive ring of the plurality of conductive rings with which it is in contact.

8. The slip ring according to claim 1 wherein said plurality of first electric tracks have a same length and a mutual spacing of at least 1 mm.

9. The slip ring according to claim 1, further comprising:
a first printed circuit board axially extended from said first electric interface within a cavity defined by said plurality of conductive rings, said first electric tracks being placed in said first printed circuit board.

10. The slip ring according to claim 9, wherein said first support body comprises a cylindrical support surface counter-shaped to radially inner surfaces of said plurality of conductive rings and a recessed seat radially spaced from said radially inner surfaces of said plurality of conductive rings, said plurality of conductive rings being fitted on said support surface and said first printed circuit board being housed in said recessed seat.

11. A method for assembling a slip ring comprising:
providing a first support body, a first electric interface configured to be electrically connected to a first electric component and associated with said first support body, a plurality of first electric tracks electrically connected to said first electric interface and extending on said first support body, a plurality of electric contacts, each electric contact being electrically connected to a respective first electric track and being elastically deformable;
exerting a pressure on said plurality of electric contacts to elastically deform said plurality of electric contacts;
arranging a plurality of conductive rings on said first support body and removing said pressure from said plurality of electric contacts so that each electric contact contacts a respective conductive ring;
coupling in sliding contact a plurality of brushes with respective conductive rings, wherein said plurality of brushes is electrically connected with a second electric interface configured to be electrically connected to a second electric component.

12. The method according to claim 11, wherein exerting a pressure on said plurality of electric contacts is implemented by pressing said electric contacts with a manoeuvring tool, and wherein arranging a plurality of conductive rings on said first support body comprises fitting each conductive ring around said manoeuvring tool and translating said conductive ring along said manoeuvring tool until an axial position of a respective electric contact is reached.

13. A slip ring comprising:
a first support body;
a first electric interface associated with said first support body and configured to be electrically connected to a first electric component;
a plurality of conductive rings fixedly mounted on said first support body;
a plurality of first electric tracks in electric connection with said first electric interface and fixedly mounted on said first support body;
a plurality of electric contacts arranged radially inside said plurality of conductive rings, each electric contact being electrically connected to a respective first electric track of the plurality of first electric tracks and being elastically deformed as it abuts against a conductive ring of the plurality of conductive rings;
a second support body rotatably coupled to said first support body about an axial rotation axis;
a second electrical interface associated with said second support body and configured to be electrically connected to a second electrical component;
a plurality of electric brushes fixedly mounted to said second support body and electrically connected to said second electrical interface, wherein each brush is arranged in sliding contact with a respective conductive ring of the plurality of conductive rings.

14. The slip ring according to claim 13, wherein each electric contact of the plurality of electric contacts comprises a first end which is fixed with respect to said first support body and electrically connected to a respective first electric track of the plurality of first electric tracks and a second end in contact against a respective conductive ring of the plurality of conductive rings.

15. The slip ring according to claim 14, wherein said plurality of electric contacts are arranged at least 0.5 mm, preferably at least 0.8 mm, even more preferably at least 1 mm apart from each other.

16. The slip ring according to claim 15, in which said plurality of electric contacts are arranged alternately in two parallel axial rows.

17. The slip ring according to claim 16 wherein each of the plurality of electrical contacts comprises a thin plate having a first end corresponding to the first end of the electrical contact and a second end corresponding to the second end of the electrical contact, the second end of the thin plate being overlapped to the first end of the thin plate so as to define a curved portion between the first end and the second end.

18. The slip ring according to claim 17, wherein the second end of each thin plate is curved and tangential to a portion of a conductive ring of the plurality of conductive rings with which it is in contact.

19. The slip ring according to claim 18, further comprising:
a first printed circuit board axially extended from said first electric interface within a cavity defined by said plurality of conductive rings, said first electric tracks being placed in said first printed circuit board.

20. The slip ring according to claim 19, wherein said first support body comprises a cylindrical support surface counter-shaped to radially inner surfaces of said plurality of conductive rings and a recessed seat radially spaced from said radially inner surfaces of said plurality of conductive rings, said plurality of conductive rings being fitted on said support surface and said first printed circuit board being housed in said recessed seat.
